(19) United States
(12) Patent Application Publication
(10) Pub. No.: US 2024/0273739 A1
(43) Pub. Date: Aug. 15, 2024

(54) APPARATUS AND METHOD WITH IMAGE REGISTRATION

(71) Applicant: SAMSUNG ELECTRONICS CO., LTD., Suwon-si (KR)

(72) Inventors: Jinje PARK, Suwon-si (KR); Jingu HEO, Suwon-si (KR); Sung Kwang CHO, Suwon-si (KR); Dong Kyung NAM, Suwon-si (KR)

(73) Assignee: SAMSUNG ELECTRONICS CO., LTD., Suwon-si (KR)

(21) Appl. No.: 18/470,536

(22) Filed: Sep. 20, 2023

(30) Foreign Application Priority Data
Feb. 10, 2023 (KR) 10-2023-0017904

(51) Int. Cl. G06T 7/30; G06T 3/00; G06T 3/40; G06T 5/00; G06T 7/20; G06T 7/50; G06V 10/75

(52) U.S. Cl. CPC G06T 7/30; G06T 3/18; G06T 3/40; G06T 5/80; G06T 7/20; G06T 7/50; G06V 10/751; G06T 2207/20228

(57) ABSTRACT

A method and an electronic device with image registration are provided. The method includes generating a first optical flow between a first partial image and a second partial image, which are captured by respective first and second cameras using an optical flow estimation model; generating disparity information between the first partial image and a third partial image, captured by a third camera, based on depth information of the first partial image generated using the first optical flow; and estimating a second optical flow between the first partial image and the third partial image based on the generated disparity information for generating a registration image.

### CROSS-REFERENCE TO RELATED APPLICATIONS

This application claims priority under 35 USC § 119(a) to Korean Patent Application No. 10-2023-0017904 filed on Feb. 10, 2023, in the Korean Intellectual Property Office, the disclosure of which is incorporated by reference herein in its entirety.

### BACKGROUND

### 1. Field

The following description relates to an apparatus and method with image registration.

### 2. Description of Related Art

For image registration, an electronic device may be typically used to detect correspondence points between two images of an object and estimate the depth of the object in the images. In the two images, the same object may be captured by a camera from different viewing points. Thus, a close proximity of the object to the camera may indicate a large displacement difference and a remote proximity of the object to the camera may indicate a small displacement difference, based on the characteristics of parallax. In this case, the electronic device may typically determine the depth of the object by a disparity that is a distance difference between a pixel in one image from one viewing point and a corresponding pixel in the other image from the other viewing point.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating a first optical flow between a first partial image and a second partial image, which are captured by respective first and second cameras using an optical flow estimation model; generating disparity information between the first partial image and a third partial image, captured by a third camera, based on depth information of the first partial image generated using the first optical flow; and estimating a second optical flow between the first partial image and the third partial image based on the generated disparity information for generating a registration image.

The generating of the first optical flow may include performing local refinement on the generated first optical flow by updating a motion vector of a candidate pixel among pixels in the generated first optical flow.

The performing of the local refinement may include generating a warped image by performing image warping on the second partial image based on the generated first optical flow; and selecting the candidate pixel, based on a difference in intensity value between corresponding pixels in the first partial image and the warped image.

The selecting of the candidate pixel may include, in response to a difference in intensity value between a first pixel in the first partial image and a second pixel in the warped image disposed at a position corresponding to the first pixel being greater than or equal to a threshold intensity, determining that a third pixel in the generated first optical flow disposed at a position corresponding to the first pixel corresponds to the candidate pixel.

The performing of the local refinement may include generating a first patch for the first pixel and a plurality of second patches for respective neighboring pixels of the second pixel in the warped image; selecting one second patch from among the generated plurality of second patches, the selected second patch having a minimum patch difference from the generated first patch; and calculating a motion vector to be updated for the third pixel in the generated first optical flow, based on a position of the first pixel in the first partial image and a pixel corresponding to the selected second patch in the warped image.

The calculating of the depth information may include generating a first corrected image and a second corrected image by correcting lens distortions for the first partial image and the second partial image, respectively.

The method may further include calculating the depth information, which may include generating, from the first optical flow, a transformed optical flow comprising information about motion vectors of respective pixels in the first corrected image, based on the first corrected image and the second corrected image; extracting a motion vector of a target pixel from the motion vectors of the transformed optical flow, and estimating the extracted motion vector as a first disparity vector between the target pixel and a pixel in the second corrected image corresponding to the target pixel; and calculating a depth value of the target pixel based on the estimated first disparity vector.

The calculating of the depth value may include calculating, as the depth value of the target pixel, a value that may be inversely proportional to a magnitude of a vector generated by subtracting a preset disparity vector from the estimated first disparity vector, wherein, for first and second images of an object having an infinite depth, respectively captured by the first camera and the second camera, the preset disparity vector may be a disparity vector between a pixel corresponding to the object in first image captured by the first camera and a pixel corresponding to the object in the second image captured by the second camera.

The estimating of the second optical flow may include generating a third corrected image by correcting lens distortion of the third partial image, and estimating, from the depth information of the first partial image, a second disparity vector between the target pixel and a pixel in the third corrected image corresponding to the target pixel.

The estimating of the second optical flow may include, based on an applying of lens distortion to each of the first corrected image and the third corrected image, estimating the second optical flow using the estimated second disparity vector.

The method may further include rearranging pixels in the second partial image to correspond to the first partial image based on the first optical flow, and rearranging pixels in the third partial image to correspond to the second partial image based on the second optical flow; and generating a high-resolution image, as the registration image, by performing image registration using the first partial image, an image generated by rearranging the pixels in the second partial image, and an image generated by rearranging the pixels in the third partial image, wherein the high-resolution image has a resolution that is greater than each of the first partial image, the second partial image, and the third partial image.

Examples include a non-transitory computer-readable storage medium storing instructions that, when executed by a processor, cause the processor to perform the method.

In another general aspect, an electronic device includes a camera array comprising a plurality of cameras; and a processor configured to generate a first optical flow between a first partial image and a second partial image, which are captured by respective first and second cameras using an optical flow estimation model; generate disparity information between the first partial image and a third partial image, captured by a third camera, based on depth information of the first partial image generated using the first optical flow; and estimate a second optical flow between the first partial image and the third partial image based on the calculated disparity information for generating an registration image.

The processor may be configured to perform local refinement on the generated first optical flow by updating a motion vector of a candidate pixel among pixels in the obtained first optical flow.

The processor may be configured to generate a warped image by performing image warping on the second partial image based on the generated first optical flow, and select the candidate pixel based on a difference in intensity value between corresponding pixels in the first partial image and the warped image.

The processor may be further configured to generate a first corrected image and a second corrected image by correcting lens distortion for the first partial image and the second partial image, respectively.

The processor may be configured to generate, from the first optical flow, a transformed optical flow comprising information about motion vectors of respective pixels in the first corrected image based on the first corrected image and the second corrected image; extract a motion vector of a target pixel from the motion vectors of the transformed optical flow; estimate the extracted motion vector as a first disparity vector between the target pixel and a pixel in the second corrected image corresponding to the target pixel; and calculate a depth value of the target pixel based on the estimated first disparity vector.

The processor may be configured to calculate, as the depth value of the target pixel, a value that may be inversely proportional to a magnitude of a vector generated by subtracting a preset disparity vector from the extracted motion vector, wherein, under the assumption that two images of an object having an infinite depth value may be respectively captured by a first camera corresponding to the first partial image and a second camera corresponding to the second partial image, the preset disparity vector may be between a pixel corresponding to the object in one image captured by the first camera and a pixel corresponding to the object in the other image captured by the second camera.

The processor may be configured to generate a third corrected image by correcting lens distortion of the third partial image, and estimate, from the depth information, a second disparity vector between the target pixel and a pixel in the third corrected image corresponding to the target pixel.

The processor may be configured to, based on applying lens distortion to each of the first corrected image and the third corrected image, estimate the second optical flow using the estimated second disparity vector.

Other features and aspects will be apparent from the following detailed description, the drawings, and the claims.

### BRIEF DESCRIPTION OF THE DRAWINGS

FIG. 1 illustrates an example electronic device including a camera array according to one or more embodiments.

FIG. 2 illustrates an example electronic device including a camera array according to one or more embodiments.

FIG. 3 illustrates an example optical flow between partial images estimated by an electronic device using an optical flow estimation model according to one or more embodiments.

FIG. 4 illustrates an example method of estimating an optical flow between partial images using an electronic device according to one or more embodiments.

FIG. 5 illustrates an example method of performing local refinement on a first optical flow between a first partial image and a second partial image using an electronic device according to one or more embodiments.

FIG. 6 illustrates an example method of performing a local search using an electronic device according to one or more embodiments.

FIG. 7 illustrates an example method of calculating depth information of a first partial image based on a first optical flow using an electronic device according to one or more embodiments.

FIG. 8 illustrates an example method of estimating a second optical flow based on depth information of a first partial image using an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

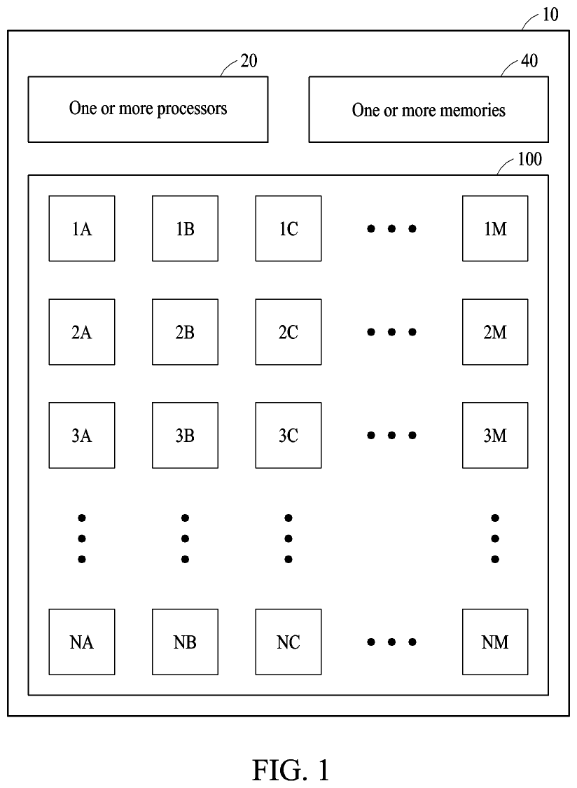

FIG. 1 illustrates an example electronic device including a camera array according to one or more embodiments.

An example electronic device 10 may include one or more processors 20, one or more memories 40, and a camera array 100. The one or more processors 20 may be configured to execute instructions and the one or more memories 40 may store the instructions and image data, such that the execution of the instructions by the one or more processors 20 may configure the one or more processors 20 and the camera array 100 to perform any one or any combination of the operations/methods described herein.

The camera array 100 may include a plurality of cameras 1A through NM. As shown in FIG. 1, the plurality of cameras 1A through NM may be arranged in a grid form in the camera array 100, but the arrangement of the plurality of cameras 1A through NM is not limited to the grid form. As non-limiting examples, the plurality of cameras 1A through NM may be arranged in a non-grid form such as a circular pattern, a zigzagged pattern, a scattered pattern or the like, in the camera array 100.

In an embodiment, the plurality of cameras 1A through NM may each include a lens and an image sensor. The image sensor may include optical sensing elements. An optical sensing element may be configured to sense optical information based on light incident onto the optical sensing element, and output a value indicating the intensity of the incident light. The optical sensing element may include a complementary metal-oxide-semiconductor (CMOS), a charge-coupled device (CCD), and a photodiode, as non-limiting examples.

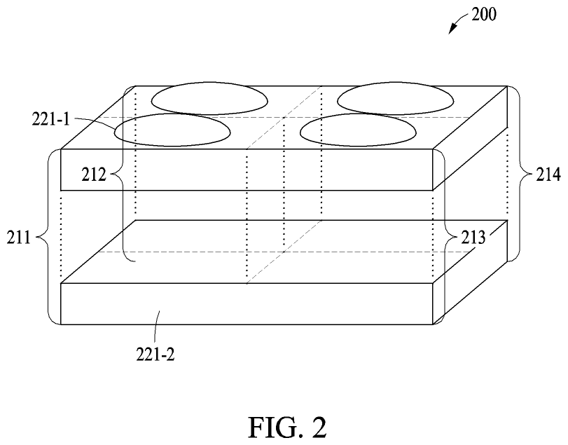

FIG. 2 illustrates an example electronic device including a camera array according to one or more embodiments.

In an embodiment, an example electronic device (e.g., the electronic device in FIG. 1) may include a camera array 200 that may be configured with a plurality of cameras 211, 212, 213, and 214. The plurality of cameras 211, 212, 213, and 214 may each include an imaging lens (e.g., an imaging lens 221-1) and an image sensor (e.g., an image sensor 221-2). The image sensor may include an optical filter and a sensing array. The optical filter may be configured with an optical characteristic that allows a predetermined wavelength band to pass therethrough and blocks the remaining wavelength bands. The optical filter may include one or more color filters. The color filters may each receive light passing through a corresponding imaging lens and transmit light corresponding to a wavelength of a single color (e.g., one of red, blue, and green) of the received light. The sensing array may include a plurality of sensing elements, and each of the sensing elements may be configured to generate sensing information based on light passing through the imaging lens.

In an embodiment, the electronic device may obtain a partial image from sensing information generated by a corresponding one of the sensing elements that sense light passing through each of the plurality of cameras 211, 212, 213, and 214. The partial image may be an image that represents a scene corresponding to a field of view (FOV) range of a corresponding imaging lens (e.g., the imaging lens 221-1). The electronic device may obtain a plurality of partial images, the number of the plurality of partial images may be the same as the number of cameras included in the camera array 200, as a non-limiting example, and may collectively correspond to wide FOV.

In an embodiment, the electronic device may generate a high-resolution image based on the plurality of partial images obtained from the plurality of respective cameras. That is, the electronic device may generate the high-resolution image by performing image registration on the obtained plurality of partial images.

In an embodiment, the electronic device may estimate an optical flow between two partial images selected from the obtained plurality of partial images to generate the high-resolution image. The optical flow may represent a motion map including a motion vector calculated for each of a plurality of pixels through comparison between the selected two partial images. For example, the motion vector may represent vector information indicating a distance by which a pixel (e.g., each corresponding to a same point on a captured object) has moved and a direction in which the pixel has moved. The electronic device may set a partial image obtained from one camera (e.g., the camera 211) as a reference image, and estimate an optical flow between the reference image and another partial image. As a non-limiting example, referring to FIG. 2, the electronic device may set, as the reference image, a first partial image obtained from the camera 211. Thus, the electronic device may estimate a first optical flow between the first partial image (the reference image) and a second partial image obtained from the camera 212, and may also estimate a second optical flow between the reference image and a third partial image obtained from the camera 213 and a third optical flow between the reference image and a fourth partial image obtained from the camera 214, as a non-limiting example.

In an embodiment, the electronic device may perform image registration on the partial images to generate a high-resolution image by rearranging pixels (e.g., consolidating) in the respective partial images based on the respective optical flows. For example, the electronic device may rearrange pixels corresponding to sensing elements receiving light from a same object at a same position in the respective partial images. Specifically, in this example, the electronic device may rearrange pixels in the second partial image to correspond to the first partial image (the reference image) based on the first optical flow. Similarly, the electronic device may rearrange pixels in the third partial image to correspond to the reference image based on the second optical flow and rearrange pixels in the fourth partial image to correspond to the reference image based on the third optical flow. The electronic device may then generate the high-resolution image by performing the image registration, using the reference image, an image generated by rearranging the pixels in the second partial image, an image generated by rearranging the pixels in the third partial image, and an image generated by rearranging the pixels in the fourth partial image. For example, while each partial image may correspond to a certain megapixel, and the registered image may be generated with four times the certain mega pixel (e.g, due to the consolidation of each of the respective pixels of the same points/positions of the object from the reference image, an image generated by rearranging the pixels in the second partial image, an image generated by rearranging the pixels in the third partial image, and an image generated by rearranging the pixels in the fourth partial image).

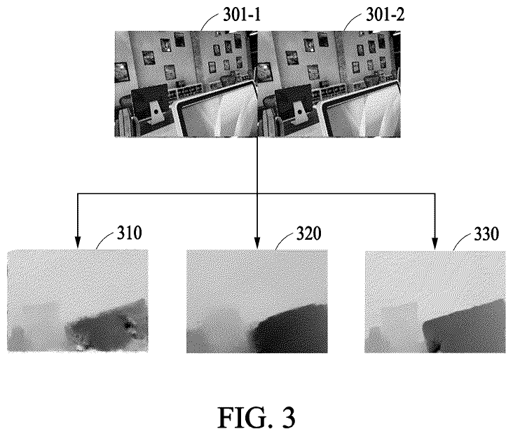

FIG. 3 illustrates an example optical flow between partial images estimated by an electronic device using an optical flow estimation model according to one or more embodiments.

In an embodiment, an electronic device (e.g., the electronic device 10 in FIG. 1) may estimate an optical flow between partial images using an optical flow estimation model. The optical flow estimation model may be a machine learning model (e.g., a pre-trained deep learning model such as a recurrent all-pairs field transforms (RAFT) model or a LiteFlowNet model), as non-limiting examples. The optical flow estimation model (e.g., the RAFT or LiteFlowNet model) may have been trained based on training data including a pair of a training input (e.g., two images) and a training output (e.g., a ground-truth (GT) optical flow between the two images) mapped to the training input. Thus, the optical flow estimation model may be a machine learning model that has been trained to output the training output based on the training input. The in-training machine learning model during training may be iteratively trained to generate a temporary output in response to the training input and minimize a loss between the temporary output and the training output. During the iterative training, parameters of the machine learning model may be updated based on the loss.

However, the pre-trained optical flow estimation model such as the RAFT model or the LiteFlowNet model may have been trained with images generated under an assumption that a camera array (e.g., the camera array 100 of FIG. 1) is in an ideal environment. The camera array in the ideal environment means that a plurality of cameras in the camera array have same camera parameters. The camera parameters may include intrinsic parameters and extrinsic parameters. The intrinsic parameters may include a focal length of an imaging lens, a principal point of the imaging lens, and a lens distortion coefficient. The extrinsic parameters may serve to express a transformation relationship between a camera coordinate system and a world coordinate system, and may be expressed as rotation and translation between the two coordinate systems. For example, a camera array in the ideal environment may include a plurality of cameras that may be arranged to face one direction in parallel, and to capture images with the same camera parameters at the same viewing point under the same image-capturing conditions. A plurality of images captured by the plurality of respective cameras may be each transformed into the same image through a shift. For example, under the assumption that a plurality of images of an object at an infinite distance are captured by the plurality of respective cameras of the camera array in the ideal environment, the plurality of captured images may all be the same image.

For the reasons set forth above, an optical flow estimation model that is pre-trained for the ideal environment may not be reliably or accurately applied to a camera array in a real environment. The camera array in the real environment may include a plurality of cameras that may not have the same camera parameters. In other words, in the camera array in the real environment, the plurality of cameras may have different optical characteristics from each other due to a design error of a lens of a camera and may have different chief ray angles (CRAs) incident on an imaging surface of the camera and different FOVs of the camera. For example, under the assumption that a plurality of images of an object at an infinite distance are captured by the plurality of cameras of the camera array in the real environment, the plurality of cameras may project the object on the plurality of respective images at different positions on an image plane. Thus, the plurality of respective captured images may all be different images.

As described above, images generated with the same camera parameters in the ideal environment are different from images generated with the different camera parameters in the real environment, and thus there may be an issue of performance deterioration when the images generated in the real environment are input to the ideal environment pre-trained optical flow estimation model to estimate an optical flow.

Therefore, referring to FIG. 3, to accurately estimate an optical flow between partial images 301-1 and 301-2 generated under the assumption that the camera array is in the real environment using the ideal environment pre-trained optical flow estimation model, performance improvement of the ideal environment pre-trained optical flow estimation model may be desirably required. For example, the ideal environment pre-trained optical flow estimation model may not be applicable to irregular lens distortion, it becomes difficult to get an accurate result/estimate of an optical flow (e.g., for generating the registration image and/or depth of the object) even when detecting correspondence points between images generated under the assumption that the camera array is in the real environment. Referring to FIG. 3, the optical flow estimation model may generate an optical flow 310 that represents an undesired result that is output in response to inputting the partial images 301-1 and 301-2 generated under the assumption that the camera array is in the real environment.

In an embodiment, in order to improve the performance of the pre-trained optical flow estimation model, the electronic device may load the pre-trained optical flow estimation model and perform fine-tuning on the loaded optical flow estimation model. Based on setting two images generated under the assumption that the camera array is in the real environment as a training input and setting a ground truth (GT) optical flow between the two images as a training output mapped to the training input, the electronic device may generate additional training data including a pair of the training input and the training output. The electronic device may receive a plurality of additional training data from outside. The electronic device may perform fine-tuning on the pre-trained optical flow estimation model using the plurality of additional training data. For example, the electronic device may measure accuracy of the pre-trained optical flow estimation model for each epoch, and train the optical flow estimation model using the plurality of additional training data until the measured accuracy reaches a preset range. That is, the electronic device may re-train the pre-trained optical flow estimation model such that it outputs an optical flow between two images based on an input of the two images generated under the assumption that the camera array is in the real environment. For example, while the pre-trained optical flow estimation model may have been trained with images from a same or ideal camera(s), such as before manufacture of an electronic device and/or generated off-device, the pre-trained optical flow estimation model may be re-trained on-device using image captured by the real camera of the electronic device. The electronic device may update parameters (e.g., weights) in the pre-trained optical flow estimation model by performing fine-tuning on the pre-trained optical flow estimation model. Referring to FIG. 3, the fine-tuned optical flow estimation model may generate an optical flow 320 (with higher resolution) that represents a better result that is output in response to inputting the partial images 301-1 and 301-2 generated under the assumption that the camera array is in the real environment.

Furthermore, in order to train/generate a pre-trained optical flow estimation model, the electronic device may load only a structure (e.g., only hyperparameters) of a pre-trained optical flow estimation model and may not load all parameters (e.g., weighted connections and/or biases) in the optical flow estimation model. That is, the electronic device may load only the structure of a pre-trained optical flow estimation model and originally determine the parameters of the optical flow estimation model. As described above, the electronic device may generate two images under the assumption that the camera array in the real environment and a GT optical flow between the two images as additional training data. The electronic device may train/generate (i.e., originally train) the optical flow estimation model in such a state that the parameters thereof are not determined yet (e.g., only initialized), using a plurality of additional training data. The electronic device may determine the parameters for the optical flow estimation model by iteratively training the optical flow estimation model using the additional training data.

Referring to FIG. 3, the re-trained or originally trained optical flow estimate models may generate an optical flow 330 that represents a better result (than using an ideal environment pre-trained optical flow estimation model) that is output in response to inputting the partial images 301-1 and 301-2 generated under the assumption the camera array is in the real environment.

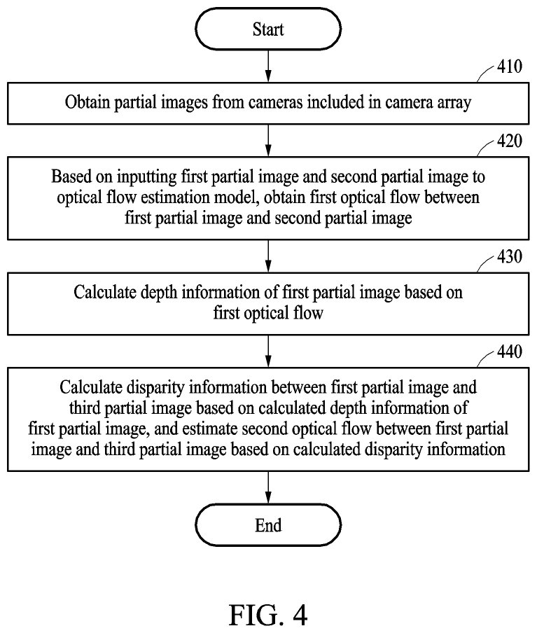

FIG. 4 illustrates an example method of estimating an optical flow between partial images by an electronic device according to one or more embodiments.

An electronic device (e.g., the electronic device 10 of FIG. 1) may be configured to estimate optical flows between a plurality of partial images captured by a plurality of respective cameras (e.g., the cameras 211, 212, 213, and 214 of FIG. 2) to generate a high-resolution image. The electronic device may set a first partial image as a reference image to estimate a respective optical flow between the reference image and each of other partial images (e.g., a second partial image, a third partial image, and a fourth partial image). In an example, after estimating one optical flow using an optical flow estimation model (e.g., a deep learning model), the electronic device may efficiently estimate other optical flows based on the estimated one optical flow. Hereinafter, an example method in which the electronic device estimates a first optical flow between the first partial image (the reference image) and the second partial image and estimates a second optical flow between the reference image and the third partial image based on the estimated first optical flow will be described as shown in a flowchart of FIG. 4.

In operation 410, the electronic device may obtain a plurality of partial images captured by a plurality of respective cameras in a camera array. As a non-limiting example, the electronic device may set, as a reference image, a first partial image among the obtained plurality of partial images.

In operation 420, based on an implementation (execution) of the optical flow estimation model by inputting the first partial image (the reference image) and a second partial image to the optical flow estimation model, the electronic device may obtain a first optical flow between the reference image and the second partial image. As described above with reference to FIG. 2, the optical flow estimation model may be a pre-trained deep leaning model (e.g., a RAFT model or a LiteFLowNet model), an originally trained model, or a fine-tuned optical flow estimation model. As will be described below, the electronic device may update the first optical flow by performing local refinement on the first optical flow estimated by and output from the optical flow estimation model.

In operation 430, the electronic device may calculate depth information of the first partial image based on the first optical flow. For example, the electronic device may calculate a depth value of each of pixels in the first partial image (the reference image). In this example, the electronic device may calculate the depth value of each pixel in the first partial image based on the first optical flow including disparity information (e.g., a disparity vector) between the first partial image and the second partial image, using an inversely proportional relationship between a depth value and a disparity vector.

In operation 440, the electronic device may calculate disparity information (e.g., a disparity vector) between the first partial image and a third partial image based on the calculated depth information (e.g., a depth value of each pixel) of the first partial image, and estimate a second optical flow between the first partial image and the third partial image based on the calculated disparity information.

The electronic device may calculate the disparity information between the first partial image and the third partial image from the depth information of the first partial image, using the inversely proportional relationship between a depth value and a disparity vector. In this case, the electronic device may have captured the first partial image using the first camera, of the camera array, that has first unique parameters, and have captured the third partial image using the third camera, of the camera array, that has third unique parameters, just as the second camera that captured the second partial image has second unique parameters.

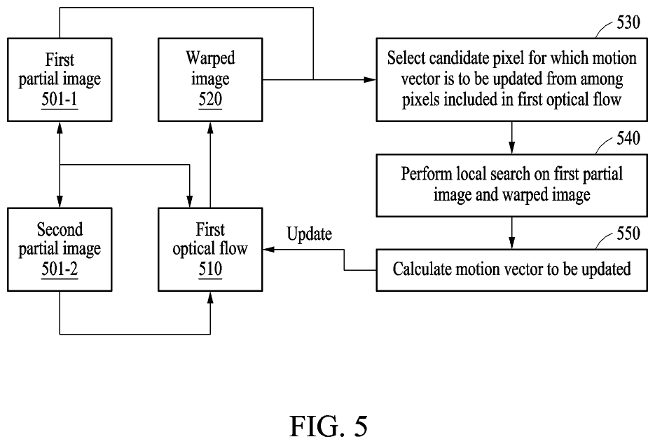

FIG. 5 illustrates an example method of performing local refinement on a first optical flow between a first partial image and a second partial image by an electronic device according to one or more embodiments.

An electronic device (e.g., the electronic device 10 in FIG. 1) may implement an optical flow estimation model, including inputting a first partial image set as a reference image and a second partial image to the optical flow estimation model, to generate a first optical flow between the reference image and the second partial image. The electronic device may perform local refinement on the generated first optical flow by updating a motion vector of a candidate pixel among pixels in the generated first optical flow.

Referring to FIG. 5, as example operations, the electronic device may input a first partial image 501-1 set as a reference image and a second partial image 501-2 to an optical flow estimation model, thereby generating a first optical flow 510. Then, the electronic device may, based on the generated first optical flow 510, perform image warping on the second partial image 501-2 to generate a warped image 520. Image warping, which refers to an image processing technique for changing a visual structure of an image, may move or transform pixels in an image to other pixel positions. As a non-limiting example, the electronic device may move a pixel position of each of pixels in the second partial image 501-2 based on a motion vector of a corresponding pixel in the first optical flow 510. The electronic device may generate the warped image 520 corresponding to the first partial image 501-1 by performing image warping on the second partial image 501-2 based on the first optical flow 510.

In operation 530, the electronic device may determine/select a candidate pixel for which a motion vector is to be updated from among the pixels in the first optical flow 510, based on a difference in intensity value between corresponding pixels in the reference image 501-1 and the warped image 520. In an example, the electronic device may generate a comparison result by compare an intensity value of a first pixel in the reference image 501-1 and an intensity value of a second pixel in the warped image 520 disposed at a pixel position corresponding to the first pixel. Based on the comparison result, the electronic device may determine whether a third pixel in the first optical flow 510 disposed at a pixel position corresponding to the first pixel corresponds to the candidate pixel. As a non-limiting example, the first pixel in the reference image 501-1, the second pixel in the warped image 520, and the third pixel in the first optical flow 510 may be pixels disposed at corresponding pixel positions in the respective images. The corresponding positions may be, for example, the same pixel position in the respective images.

In an embodiment, in response to a difference between the intensity value of the first pixel in the reference image 501-1 and the intensity value of the second pixel in the warped image 520 being greater than or equal to a threshold intensity, the electronic device may determine that the third pixel in the first optical flow 510 corresponds to the candidate pixel. That is, when the intensity value of the first pixel and the intensity value of the second pixel differ by a value equal to or greater than the threshold intensity, the electronic device may determine that a motion vector of the third pixel in the first optical flow 510 is unreliable. When determining that the third pixel in the first optical flow 510 corresponds to the candidate pixel, the electronic device may update the motion vector of the third pixel in the first optical flow 510.

In operation 540, the electronic device may perform a local search on the reference image 501-1 and the warped image 520 to update the motion vector corresponding to the third pixel. Through the local search on the reference image 501-1 and the warped image 520, the electronic device may reselect a pixel in the warped image 520 corresponding to the first pixel in the reference image 501-1.

In operation 550, the electronic device may calculate a motion vector to be updated for the third pixel. For example, the electronic device may calculate the motion vector to be updated for the third pixel based on the first pixel in the reference image 501-1 and the reselected pixel in the warped image 520. The electronic device may update the motion vector of the third pixel in the first optical flow 510 using the calculated motion vector.

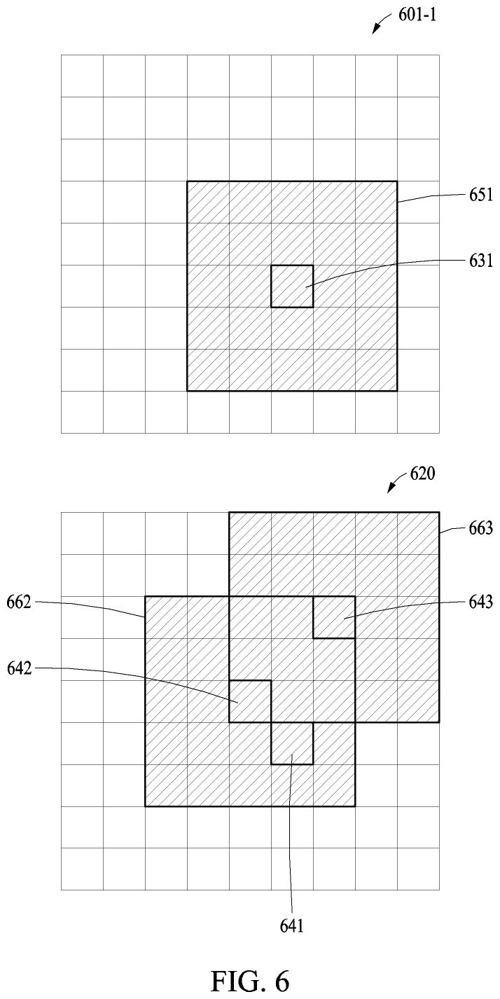

FIG. 6 illustrates an example method of performing a local search by an electronic device according to one or more embodiments.

An electronic device (e.g., the electronic device 10 in FIG. 1) may determine that a third pixel in a first optical flow corresponds to a candidate pixel. For example, the electronic device may generate a first patch 651 for a first pixel 631 in a first partial image 601-1 (the reference image) disposed at a position corresponding to the third pixel in the first optical flow. The first patch 651 may be a patch having a predetermined size with the first pixel 631 being at a center thereof. As shown in FIG. 6, the first patch 651 may have a size of 5×5 as a non-limiting example. The electronic device may generate a plurality of second patches (e.g., second patches 662 and 663) for neighboring pixels (e.g., pixels 642 and 643) of a second pixel 641 in a warped image 620 disposed at a position corresponding to the third pixel in the first optical flow. For example, the second patch 662 may be a patch having a predetermined size with the pixel 642 being at a center thereof, and the second patch 663 may be a patch having a predetermined size with the pixel 643 being at a center thereof. The neighboring pixels 642 and 643 of the second pixel 641 may be pixels that are separated from the second pixel 641 by a predetermined distance. The size of each of the second patches may be the same as that of the first patch as a non-limiting example.

In one embodiment, the electronic device may select a single second patch (e.g., the second patch 662) that has a minimum patch difference from the first patch 651 among the generated plurality of second patches (e.g., the second patches 662 and 663). For example, a patch difference between two patches may be defined as a root mean square of a difference in intensity value between corresponding pixels in the two patches, but the patch difference between the two patches may not be limited thereto.

In one embodiment, the electronic device may calculate a motion vector to be updated for the third pixel in the first optical flow, based on the first pixel 631 in the first partial image 601-1 and a pixel (e.g., the pixel 642) corresponding to the selected second patch (e.g., the second patch 662) in the warped image 620. For example, the electronic device may determine the motion vector to be updated to a difference between a pixel position of the first pixel in the first partial image 601-1 and a pixel position at which the pixel in the warped image 620 has been disposed in the second partial image 501-2 before being warped through image warping. The electronic device may update the motion vector of the third pixel in the first optical flow to the calculated motion vector.

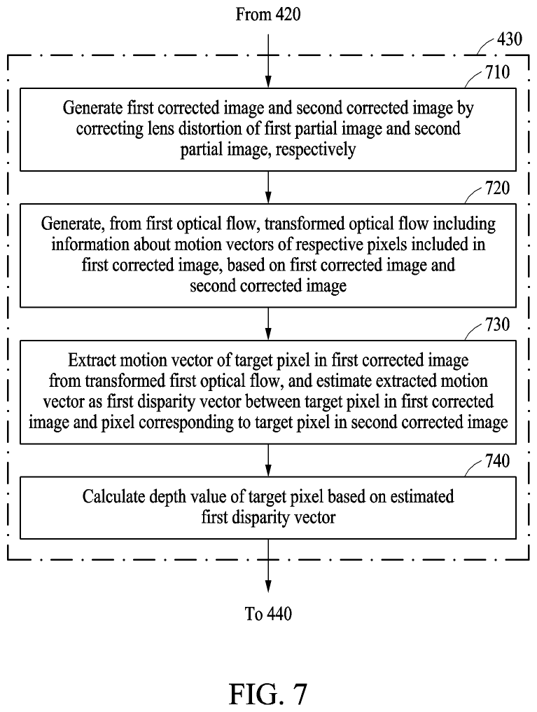

FIG. 7 illustrates an example method of calculating depth information of a first partial image based on a first optical flow by an electronic device according to one or more embodiments.

In operation 710, the electronic device may generate a first corrected image and a second corrected image by correcting lens distortion for a first partial image and a second partial image, respectively.

The electronic device may generate the first corrected image by correcting lens distortion of the first partial image using an intrinsic parameter of a first camera capturing the first partial image set as a reference image. For example, the electronic device may correct the lens distortion of the reference image by applying a lens distortion coefficient of the first camera to the reference image. Similarly, the electronic device may generate the second corrected image by correcting the lens distortion of the second partial image using an intrinsic parameter of a second camera capturing the second partial image. For example, the electronic device may correct the lens distortion of the second partial image by applying a lens distortion coefficient of the second camera to the second partial image.

In operation 720, the electronic device may generate, from a first optical flow, a transformed optical flow including information about a motion vector of each of pixels in the first corrected image, based on the first corrected image and the second corrected image. That is, since lens distortion is applied to the reference image captured by the first camera and the second partial image captured by the second camera, the electronic device may extract correspondence points between the first corrected image and the second corrected image in which the lens distortion is corrected.

For example, the electronic device may calculate a motion vector for each of pixels in the first corrected image by matching each pixel in the first corrected image to a corresponding pixel in the second corrected image. In this example, the electronic device may calculate a motion vector for a target pixel of the first corrected image by selecting a pixel in the second corrected image corresponding to the target pixel in the first corrected image. In this example, the electronic device may use the first optical flow to select the pixel in the second corrected image corresponding to the target pixel in the first corrected image. The electronic device may extract, from the first optical flow, a motion vector of a pixel in the reference image that is before the lens distortion is corrected and corresponds to the target pixel of the first corrected image. The electronic device may identify a pixel in the second partial image corresponding to the pixel in the reference image, using the extracted motion vector. The electronic device may also identify, as the pixel in the second corrected image corresponding to the target pixel in the first corrected image, a pixel in the second corrected image that is after the lens distortion is corrected and corresponds to the identified pixel in the second partial image. The electronic device may calculate, as the motion vector of the target pixel, a vector indicating a difference between a pixel position of the target pixel in the first corrected image and a pixel position of the pixel in the second corrected image corresponding to the target pixel.

In operation 730, the electronic device may extract the motion vector of the target pixel in the first corrected image from the transformed optical flow, and estimate the extracted motion vector as a first disparity vector between the target pixel in the first corrected image and the pixel in the second corrected image corresponding to the target pixel.

In operation 740, the electronic device may calculate a depth value of the target pixel based on the estimated first disparity vector. For example, the electronic device may calculate, as the depth value of the target pixel, a value that is inversely proportional to a magnitude of a vector obtained by subtracting, from the estimated first disparity vector, a preset disparity vector for a combination of the first camera capturing the reference image and the second camera capturing the second partial image. In this example, the preset disparity vector for the combination of the first camera and the second camera may refer to, under the assumption that images of an object having an infinite depth value are respectively captured by the first camera and the second camera, a disparity vector between a pixel corresponding to the object in the image captured by the first camera and a pixel corresponding to the object in the image captured by the second camera.

Equation 1 may express a relationship between the first disparity vector between the target pixel in the first corrected image and the pixel in the second corrected image corresponding to the target pixel and a depth value of the target pixel in the first corrected image.

$$d ( x ) - {d}_{∞} ( x ) = m ( x ) ( \frac{1}{Z ( x )} ) \qquad Equation 1$$

In Equation 1, d(x) denotes the first disparity vector between the target pixel in the first corrected image and the pixel in the second corrected image corresponding to the target pixel, d_{∞}(x) denotes a preset disparity vector for a combination of the first camera and the second camera, m(x) denotes a gradient vector associated with the combination of the first camera and the second camera, and Z(x) denotes a depth value of the target pixel in the first corrected image.

In an embodiment, under the assumption that the first camera and the second camera do not rotate, the respective cameras (e.g., the first camera and the second camera) have the same intrinsic parameter values, and there is no lens distortion in each camera, the gradient vector m(x) associated with the combination of the first camera and the second camera may be expressed by Equation 2.

$$m ( x ) = f \cdot T \qquad Equation 2$$

In Equation 2, f denotes a focal length of the first camera or the second camera, and T denotes a distance between a center point of the first camera and a center point of the second camera.

However, in a real environment, the first camera and the second camera may rotate and may have different intrinsic parameter values, and there may be lens distortion in the first camera and the second camera. Accordingly, the electronic device may calculate the gradient vector m(x) associated with the combination of the first camera and the second camera in consideration of parameters of the first camera and parameters of the second camera.

In summary, the electronic device may calculate in advance the gradient vector m(x) associated with the combination of the first camera and the second camera and the preset disparity vector d_{∞}(x) for the combination of the first camera and the second camera. In a case in which the gradient vector m(x) and the disparity vector d_{∞}(x) are preset in Equation 1 above, the depth value Z(x) of the target pixel may be calculated from the first disparity vector d(x) of the target pixel.

The electronic device may calculate a depth value Z(x) for each of the pixels in the first corrected image. In addition, depth information of the first partial image (the reference image) may include information about respective depth values of the pixels in the first corrected image generated by correcting the lens distortion in the first partial image.

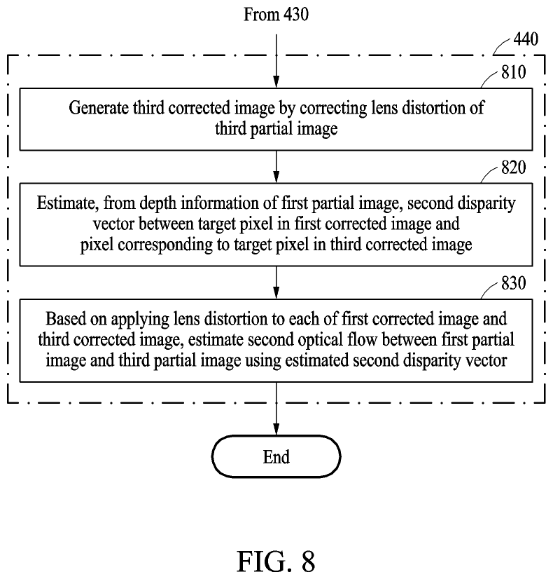

FIG. 8 illustrates an example method of estimating a second optical flow based on depth information of a first partial image by an electronic device according to one or more embodiments.

In operation 810, the electronic device may generate a third corrected image by correcting lens distortion of a third partial image. The third partial image may be an image captured by a third camera.

In operation 820, the electronic device may estimate, based on the depth information of the first partial image (the reference image), a second disparity vector between the target pixel in the first corrected image and a pixel in the third corrected image corresponding to the target pixel. The electronic device may use respective parameters of the first camera and the third camera to estimate the second disparity vector between the target pixel in the first corrected image and the pixel in the third corrected image corresponding to the target pixel.

Equation 3 may express a relationship between the second disparity vector between the target pixel in the first corrected image and the pixel in the third corrected image corresponding to the target pixel and a depth value of the target pixel in the first corrected image.

$$d ( x ) - {d}_{∞} ( x ) = m ( x ) ( \frac{1}{Z ( x )} ) \qquad Equation 3$$

Equation 3 is the same as Equation 1 except that values of a disparity vector d_{∞}(x) and a gradient vector m(x) are different in the respective equations. In Equation 3, the disparity vector d_{∞}(x) may be a preset disparity vector for a combination of the first camera and the third camera, and the gradient vector m(x) may be a gradient vector associated with the combination of the first camera and the third camera.

For example, under the assumption that images of an object having an infinite depth value are respectively captured by the first camera and the third camera, a disparity vector between a pixel in the image captured by the first camera and a pixel in the image captured by the third camera may be calculated as the disparity vector d_{∞}(x) in Equation 3. In addition, the gradient vector m(x) associated with the combination of the first camera and the third camera may be calculated in consideration of respective camera parameters of the first camera and the third camera.

In Equation 3, since the depth value Z(x) of the target pixel has already been calculated in operation 740 of FIG. 7, the electronic device may estimate a second disparity vector d(x) between the target pixel in the first corrected image and the pixel in the third corrected image corresponding to the target pixel, based on the previously calculated depth value Z(x) of the target pixel.

In one embodiment, the electronic device may estimate, as the second disparity vector d(x), a value that is inversely proportional to the depth value Z(x) of the target pixel in the first corrected image. For example, the electronic device may estimate, as the second disparity vector associated with the target pixel, a vector obtained by calculating a sum of a vector value

$$m ( x ) = ( \frac{1}{Z ( x )} )$$

generated by dividing the gradient vector (m(x) associated with the combination of the first camera and the third camera by the depth value Z(x) of the target pixel and the preset disparity vector d_{∞}(x) preset for the combination of the first camera and the third camera.

In operation 830, based on applying lens distortion to each of the first corrected image and the third corrected image, the electronic device may estimate a second optical flow between the first partial image (the reference image) and the third partial image using the estimated second disparity vector. That is, since the electronic device has already extracted correspondence points between the first corrected image and the third corrected image in which the lens distortion is corrected by estimating the second disparity vector, the electronic device may reapply the lens distortion and estimate correspondence points between the reference image and the third partial image to estimate the second optical flow.

To estimate the second optical flow between the reference image captured by the first camera and the third partial image captured by the third camera, the electronic device may reapply lens distortion to each of the first corrected image and the third corrected image. For example, first, the electronic device may identify a pixel in the third corrected image corresponding to the target pixel in the first corrected image through the estimated second disparity vector. The electronic device may apply lens distortion to the first corrected image and identify a pixel in the reference image to which the lens distortion is applied corresponding to the target pixel in the first corrected image. The electronic device may also apply lens distortion to the third corrected image and identify a pixel in the third partial image to which the lens distortion is applied corresponding to the pixel in the third corrected image corresponding to the target pixel. The electronic device may calculate, as a motion vector for the identified pixel in the reference image, a vector indicating a difference between a pixel position of the identified pixel in the reference image and a pixel position of the identified pixel in the third partial image. Similarly, the electronic device may calculate a motion vector for each of a plurality of pixels in the reference image, and estimate the second optical flow between the reference image and the third partial image including the calculated motion vectors.

The processors, memories, electronic devices, apparatuses, cameras, camera arrays, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, comprising:
generating a first optical flow between a first partial image and a second partial image, which are captured by respective first and second cameras using an optical flow estimation model;
generating disparity information between the first partial image and a third partial image, captured by a third camera, based on depth information of the first partial image generated using the first optical flow; and
estimating a second optical flow between the first partial image and the third partial image based on the generated disparity information for generating a registration image.

2. The method of claim 1, wherein the generating of the first optical flow comprises:
performing local refinement on the generated first optical flow by updating a motion vector of a candidate pixel among pixels in the generated first optical flow.

3. The method of claim 2, wherein the performing of the local refinement comprises:
generating a warped image by performing image warping on the second partial image based on the generated first optical flow; and
selecting the candidate pixel, based on a difference in intensity value between corresponding pixels in the first partial image and the warped image.

4. The method of claim 3, wherein the selecting of the candidate pixel comprises:
in response to a difference in intensity value between a first pixel in the first partial image and a second pixel in the warped image disposed at a position corresponding to the first pixel being greater than or equal to a threshold intensity, determining that a third pixel in the generated first optical flow disposed at a position corresponding to the first pixel corresponds to the candidate pixel.

5. The method of claim 4, wherein the performing of the local refinement comprises:
generating a first patch for the first pixel and a plurality of second patches for respective neighboring pixels of the second pixel in the warped image;
selecting one second patch from among the generated plurality of second patches, the selected second patch having a minimum patch difference from the generated first patch; and
calculating a motion vector to be updated for the third pixel in the generated first optical flow, based on a position of the first pixel in the first partial image and a pixel corresponding to the selected second patch in the warped image.

6. The method of claim 1, wherein the calculating of the depth information comprises:
generating a first corrected image and a second corrected image by correcting lens distortions for the first partial image and the second partial image, respectively.

7. The method of claim 6, further comprising calculating the depth information, comprising:
generating, from the first optical flow, a transformed optical flow comprising information about motion vectors of respective pixels in the first corrected image, based on the first corrected image and the second corrected image;
extracting a motion vector of a target pixel from the motion vectors of the transformed optical flow, and estimating the extracted motion vector as a first disparity vector between the target pixel and a pixel in the second corrected image corresponding to the target pixel; and
calculating a depth value of the target pixel based on the estimated first disparity vector.

8. The method of claim 7, wherein the calculating of the depth value comprises:
calculating, as the depth value of the target pixel, a value that is inversely proportional to a magnitude of a vector generated by subtracting a preset disparity vector from the estimated first disparity vector, and
wherein, for first and second images of an object having an infinite depth, respectively captured by the first camera and the second camera, the preset disparity vector is a disparity vector between a pixel corresponding to the object in first image captured by the first camera and a pixel corresponding to the object in the second image captured by the second camera.

9. The method of claim 7, wherein the estimating of the second optical flow comprises:
generating a third corrected image by correcting lens distortion of the third partial image, and estimating, from the depth information of the first partial image, a second disparity vector between the target pixel and a pixel in the third corrected image corresponding to the target pixel.

10. The method of claim 9, wherein the estimating of the second optical flow comprises:
based on an applying of lens distortion to each of the first corrected image and the third corrected image, estimating the second optical flow using the estimated second disparity vector.

11. The method of claim 1, further comprising:
rearranging pixels in the second partial image to correspond to the first partial image based on the first optical flow, and rearranging pixels in the third partial image to correspond to the second partial image based on the second optical flow; and
generating a high-resolution image, as the registration image, by performing image registration using the first partial image, an image generated by rearranging the pixels in the second partial image, and an image generated by rearranging the pixels in the third partial image, wherein the high-resolution image has a resolution that is greater than each of the first partial image, the second partial image, and the third partial image.

12. A non-transitory computer-readable storage medium storing instructions that, when executed by a processor, cause the processor to perform the method of claim 1.

13. An electronic device, comprising:
a camera array comprising a plurality of cameras; and
a processor configured to:
generate a first optical flow between a first partial image and a second partial image, which are captured by respective first and second cameras using an optical flow estimation model;
generate disparity information between the first partial image and a third partial image, captured by a third camera, based on depth information of the first partial image generated using the first optical flow; and
estimate a second optical flow between the first partial image and the third partial image based on the calculated disparity information for generating an registration image.

14. The electronic device of claim 13, wherein the processor is configured to:
perform local refinement on the generated first optical flow by updating a motion vector of a candidate pixel among pixels in the obtained first optical flow.

15. The electronic device of claim 14, wherein the processor is configured to:
generate a warped image by performing image warping on the second partial image based on the generated first optical flow, and select the candidate pixel based on a difference in intensity value between corresponding pixels in the first partial image and the warped image.

16. The electronic device of claim 13, wherein the processor is further configured to:
generate a first corrected image and a second corrected image by correcting lens distortion for the first partial image and the second partial image, respectively.

17. The electronic device of claim 16, wherein the processor is configured to:
generate, from the first optical flow, a transformed optical flow comprising information about motion vectors of respective pixels in the first corrected image based on the first corrected image and the second corrected image;
extract a motion vector of a target pixel from the motion vectors of the transformed optical flow;
estimate the extracted motion vector as a first disparity vector between the target pixel and a pixel in the second corrected image corresponding to the target pixel; and
calculate a depth value of the target pixel based on the estimated first disparity vector.

18. The electronic device of claim 17, wherein the processor is configured to:
calculate, as the depth value of the target pixel, a value that is inversely proportional to a magnitude of a vector generated by subtracting a preset disparity vector from the extracted motion vector,
wherein, under the assumption that two images of an object having an infinite depth value are respectively captured by a first camera corresponding to the first partial image and a second camera corresponding to the second partial image, the preset disparity vector is between a pixel corresponding to the object in one image captured by the first camera and a pixel corresponding to the object in the other image captured by the second camera.

19. The electronic device of claim 17, wherein the processor is configured to:
generate a third corrected image by correcting lens distortion of the third partial image, and estimate, from the depth information, a second disparity vector between the target pixel and a pixel in the third corrected image corresponding to the target pixel.

20. The electronic device of claim 19, wherein the processor is configured to:
based on applying lens distortion to each of the first corrected image and the third corrected image, estimate the second optical flow using the estimated second disparity vector.
